(19) United States
(12) Patent Application Publication
(10) Pub. No.: US 2025/0391150 A1
(43) Pub. Date: Dec. 25, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: YASUYUKI YAMAZAKI, Tokyo (JP)

(21) Appl. No.: 19/239,081

(22) Filed: Jun. 16, 2025

(30) Foreign Application Priority Data
Jun. 20, 2024 (JP) 2024-099754

(51) Int. Cl. G06V 10/74; G06T 7/20; G06V 10/44; G06V 10/82

(52) U.S. Cl. CPC G06V 10/761; G06T 7/20; G06V 10/44; G06V 10/82

(57) ABSTRACT

An information processing apparatus includes at least one processor and at least one memory. The at least one memory stores instructions for causing the at least one processor and the at least one memory to obtain a plurality of time-series images; select a reference image and a search image from among the plurality of time-series images based on at least any of a time at which the plurality of time-series images is captured, a predetermined time interval, and a dissimilarity degree between the plurality of time-series images; and infer, based on the reference image and the search image selected from among the plurality of time-series images, a target subject in the search image that corresponds to a target subject in the reference image to update a parameter of a neural network based on an inference result and ground truth data.

### BACKGROUND

### Field of the Disclosure

The present disclosure relates to an information processing technique for training a neural network.

### Description of the Related Art

As an object tracking technique using a multilayered neural network, “SiamFC++: Towards Robust and Accurate Visual Tracking with Target Estimation Guidelines” by Yinda Xu et al., AAAI 2020 discusses a technique of inputting a reference image including a tracking target subject, searching a given search image for the tracking target subject, and inferring the position and the size of tracking target subject. To perform such object tracking, a reference image, a search image, and a piece of ground truth data indicating a position and a size of a tracking target subject that corresponds to those images need to be prepared for training parameters in a multilayered. In order to adequately train parameters of a multilayered neural network, a large amount of data is required, and open datasets as discussed in “LaSOT: A High-Quality Benchmark for Large-Scale Single Object Tracking” by Heng Fan et al., CVPR 2019 are generally used. In “SiamFC++: Towards Robust and Accurate Visual Tracking with Target Estimation Guidelines” by Yinda Xu et al., AAAI 2020, to train parameters of a multilayered neural network, a reference image and a search image are selected from a moving image discussed in “LaSOT: A High-Quality Benchmark for Large-Scale Single Object Tracking” by Heng Fan et al., CVPR 2019, in such a manner that the frame intervals are 100 or less.

In many cases, devices, such as cameras, have a function of performing object tracking. In devices such as cameras, mountable circuits, calculation capability, and processing times, and the like are restricted and it is difficult to use a multilayered neural network of the scale discussed in “SiamFC++: Towards Robust and Accurate Visual Tracking with Target Estimation Guidelines” by Yinda Xu et al., AAAI 2020. Thus, it is necessary to use a model with a drastically-reduced number of parameters. However, if the number of parameters of a multilayered neural network is drastically reduced, it is difficult to train a model adapted to all the various tracking target subjects as discussed in “LaSOT: A High-Quality Benchmark for Large-Scale Single Object Tracking” by Heng Fan et al., CVPR 2019. To address this, it is considered to independently prepare a training dataset (sets of reference images and search images) dedicated to a function of a device equipped with a multilayered neural network using data on a captured moving image of a tracking target subject.

### SUMMARY

The present disclosure is directed to enabling a neural network training robust against variations in target subjects, even when moving image data to be used for training varies in length.

According to an aspect of the present disclosure, an information processing apparatus includes at least one processor and at least one memory that is in communication with the at least one processor. The at least one memory stores instructions for causing the at least one processor and the at least one memory to obtain a plurality of time-series images; select a reference image and a search image from among the plurality of time-series images based on at least any of a time at which the plurality of time-series images is captured, a predetermined time interval, and a dissimilarity degree between the plurality of time-series images; and infer, based on the reference image and the search image selected from among the plurality of time-series images, a target subject in the search image that corresponds to the target subject in the reference image to update a parameter of a neural network based on an inference result and ground truth data.

Further features of various embodiments will become apparent from the following description of exemplary embodiments with reference to the attached drawings.

### BRIEF DESCRIPTION OF THE DRAWINGS

FIG. 1 is a diagram illustrating a functional configuration example of an information processing apparatus.

FIG. 2 is a flowchart illustrating information processing according to an exemplary embodiment.

FIGS. 3A and 3B are flowcharts illustrating processing of selecting a reference image and a search image, respectively.

FIGS. 4A and 4B are diagrams illustrating reference image feature obtaining processing and search image feature obtaining processing.

FIGS. 5A and 5B are diagrams each illustrating an example of a mesh grid and a positional shift amount map.

FIGS. 6A to 6C are tables illustrating a similarity degree, a dissimilarity degree, and a sampling probability, respectively.

FIG. 7 is a diagram illustrating a hardware configuration example of the information processing apparatus.

### DESCRIPTION OF THE EMBODIMENTS

Hereinafter, exemplary embodiments according to the present disclosure will be described with reference to the drawings. The following exemplary embodiments are not intended to limit the present disclosure. In addition, not all of a plurality of features described in the present exemplary embodiment is essential to the solution of the present disclosure, and the plurality of features may be arbitrarily combined. The configurations of the exemplary embodiments can be appropriately modified or changed depending on the specifications of an apparatus to which the present disclosure is applied, and various conditions (use condition, use environment, etc.). The exemplary embodiments to be described be in the following may be partially combined as appropriate. In the following exemplary embodiments, the same or similar components and the same or similar processing processes are assigned the same reference numerals, and the redundant description will be omitted.

A first exemplary embodiment will be described. In the present exemplary embodiment, an example will be described of applying object tracking with a multilayered neural network to a camera autofocus function. As a subject targeted by the camera autofocus function, examples include subjects with vigorous movements, such as a player in a competitive sport, a moving bird or animal, or a running automobile or motorbike. Subjects with vigorous movement are those whose appearance easily varies significantly due to changes in posture and other factors. In the present exemplary embodiment, an example will be described of enabling the training of a multilayered neural network that can perform robust and efficient object tracking for such subjects whose appearance varies significantly.

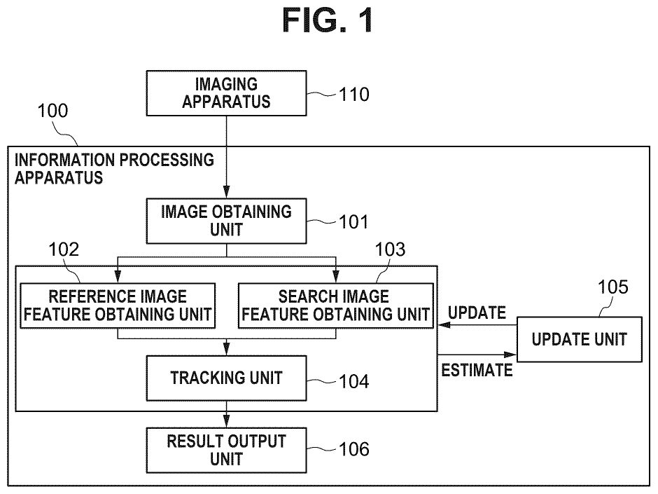

FIG. 1 is a schematic diagram illustrating a functional configuration example of an information processing apparatus according to the present exemplary embodiment.

The overview of the information processing apparatus according to the present exemplary embodiment will now be described.

An imaging apparatus 110 is a digital camera or a monitoring camera including an imaging optical system, an image sensor, and imaging and signal processing circuit systems. The imaging apparatus 110 outputs data on a captured moving image of a subject to an information processing apparatus 100.

An image obtaining unit 101 of the information processing apparatus 100 obtains the data on the moving image from the imaging apparatus 110. In the present exemplary embodiment, the image obtaining unit 101 selects data on at least one moving image from among a plurality of moving images captured by the imaging apparatus 110. The details of moving image selection processing executed by the image obtaining unit 101 will be described below.

A reference image feature obtaining unit 102 selects an image as a reference image from the moving image selected by the image obtaining unit 101, and extracts an image feature from the selected reference image. The reference image is an image in which a tracking target subject appears. The reference image feature obtaining unit 102 according to the present exemplary embodiment extracts an image feature using a multilayered neural network, which will be described below in detail. Hereinafter, an image feature extracted from a reference image will be referred to as a reference image feature. The reference image obtaining and reference image feature extraction processing executed by the reference image feature obtaining unit 102 will be described below in detail. The reference image feature extracted by the reference image feature obtaining unit 102 is transmitted to a tracking unit 104.

A search image feature obtaining unit 103 selects an image as a search image from the moving image selected by the image obtaining unit 101, and extracts an image feature from the selected search image. The search image is used in search for a tracking target subject. The search image feature obtaining unit 103 according to the present exemplary embodiment extracts an image feature using a multilayered neural network, which will be described below in detail. Hereinafter, an image feature extracted from a search image will be referred to as a search image feature. The search image obtaining and search image feature extraction processing executed by the search image feature obtaining unit 103 will be described below in detail. The search image feature extracted by the search image feature obtaining unit 103 is transmitted to the tracking unit 104.

The tracking unit 104 receives the reference image feature and the search image feature, and infers the position and the size of a tracking target subject (hereinafter, will be referred to as a tracking target) in the search image that correspond to the tracking target in the reference image. The tracking unit 104 according to the present exemplary embodiment infers the position and the size of the tracking target using a multilayered neural network, which will be described below in detail.

An update unit 105 receives an inference result from the tracking unit 104, and calculates a difference between the inference result and preliminarily-input ground truth. The update unit 105 updates parameters of the multilayered neural network based on the difference to perform training that optimizes the parameters. The update unit 105 according to the present exemplary embodiment updates adjustable parameters of the multilayered neural networks in the reference image feature obtaining unit 102, the search image feature obtaining unit 103, and the tracking unit 104 to optimize the parameters, which will be described below in detail. The update unit 105 may update parameters of all the multilayered neural networks in the reference image feature obtaining unit 102, the search image feature obtaining unit 103, and the tracking unit 104, or may update parameters of one or two of those multilayered neural networks. Further, parameters of the multilayered neural networks can be updated using a method, such as a stochastic gradient descent method.

A result output unit 106 outputs tracking results, i.e., inference results, of the position and the size of a tracking target, which are obtained by the tracking unit 104 using the multilayered neural network after the parameters have been optimized through training as described above. In other words, the result output unit 106 outputs the tracking results of a tracking target obtained by the tracking unit 104 using the feature amounts acquired by the reference image feature obtaining unit 102 and the search image feature obtaining unit 103 after the parameters have been optimized through training. In the present exemplary embodiment, inference results output from the result output unit 106 are used in operations, such as a camera autofocus function. In other words, an inference result is a tracking result of a tracking target, the subject of the tracking result is focused with autofocusing in a camera.

In the present exemplary embodiment, an example is described where tracking results using a trained multilayered neural network are output from the result output unit 106. However, the tracking results can also be used to verify the effect of updates performed by the update unit 105. In other words, by outputting tracking results using a multilayered neural network being trained from the result output unit 106 and checking a camera for the autofocus operation based on the tracking results, a user can confirm whether the training is being conducted appropriately.

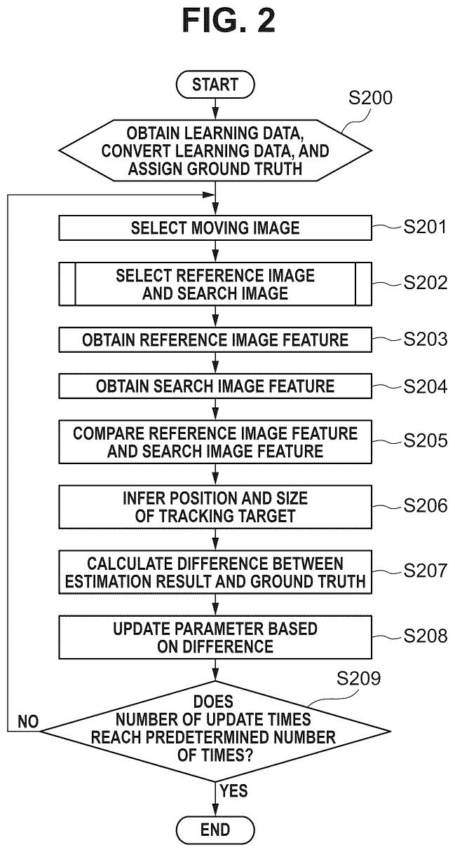

FIG. 2 is a flowchart illustrating a procedure of information processing in the information processing apparatus 100 according to the present exemplary embodiment. The overview of information processing according to the present exemplary embodiment will be described with reference to the flowchart in FIG. 2, and then, the details of processing performed in each step in FIG. 2 will be described.

In step S200 as preparatory processing before the processing from step 201 onwards, acquisition of learning data, predetermined conversion processing on the learning data, and assignment of ground truth are performed in the information processing apparatus 100. In the present exemplary embodiment, a plurality of moving images (continuous images) including a plurality of frames (shots) captured in a time series by the imaging apparatus 110 is used as learning data.

In step S201, the image obtaining unit 101 selects a moving image to be used for training from among the plurality of moving images prepared in advance in step S200.

In step S202, the reference image feature obtaining unit 102 and the search image feature obtaining unit 103 selects a pair of a reference image and a search image other than the reference image from the moving image selected by the image obtaining unit 101 based on a preset time interval.

In step S203, the reference image feature obtaining unit 102 extracts a reference image feature from the reference image, and transmits the reference image feature to the tracking unit 104. In step S204, the search image feature obtaining unit 103 extracts a search image feature from the search image, and transmits the search image feature to the tracking unit 104.

In step S205, the tracking unit 104 compares the reference image feature and the search image feature.

In step S206, the tracking unit 104 infers the position and the size of the tracking target in the search image based on the comparison result of the reference image feature and the search image feature, and transmits the inference result to the update unit 105.

In step S207, the update unit 105 compares the inference result transmitted from the tracking unit 104 and the ground truth prepared in advance to calculate a difference therebetween.

In step S208, the update unit 105 updates parameters of multilayered neural networks respectively used in the reference image feature obtaining unit 102, the search image feature obtaining unit 103, and the tracking unit 104 to optimize the parameters based on the calculated difference.

In step S209, the information processing apparatus 100 determines whether to end the processing. For example, if the number of parameter updates reaches a predetermined number of times, the information processing apparatus 100 ends the processing. If the number of parameter updates does not reach the predetermined number of times, the processing returns to step S201. In the present exemplary embodiment, the predetermined number of times is set to 10000.

The processing in each step of the flowchart in FIG. 2 will now be described in detail.

### <Preparatory Processing>

In step S200, the information processing apparatus 100 collects a sufficient number of pairs of learning data and ground truth data, and performs predetermined conversion processing on the learning data. The learning data is, for example, a red, green, and blue (RGB) moving image with a width of 4000 pixels, a height of 3000 pixels, and 30 frames as the number of frames captured by the imaging apparatus 110, such as a digital camera. The predetermined conversion processing on the learning data is processing of converting a moving image into an image sequence. The information processing apparatus 100 then performs processing of assigning ground truth data to all the images in the converted image sequence. The ground truth data indicates the position, the width, and the height (i.e., the size) of a tracking target in each image. As these data values, for example, values input by the user, or values calculated from a tracking target region detected in an image are used.

The information processing apparatus 100 according to the present exemplary embodiment selects a pair of a reference image and a search image from a moving image based on preset time intervals, and thus, when selecting a pair of the reference image and the search image, the information processing apparatus 100 refers to the image capturing time of each frame of the moving image, which will be described below in detail. Thus, it is desirable that moving images of all pieces of learning data be captured with an equal number of frames. However, it is not always possible to obtain moving images with an equal number of frames as moving images of learning data, and moving images with varying number of frames, i.e., moving images with different lengths from each other are obtained in many cases. In the present exemplary embodiment, a time stamp indicating an image capturing time (image capturing date and time) of an image of each frame is applied to a moving image captured by the imaging apparatus 110, and the reference image feature obtaining unit 102 and the search image feature obtaining unit 103 refer to the time stamp when selecting a reference image and a search image, respectively, in step S202, which will be described below. In the present exemplary embodiment, a method of storing learning data is not particularly limited. For example, learning data may be stored in an external storage device such as a hard disc, or may be stored in a cloud storage connected via a network.

### <Moving Image Selection Processing>

The moving image selection processing performed by the image obtaining unit 101 in step S201 of FIG. 2 will now be described.

In step S201, the image obtaining unit 101 selects a moving image used for training from among a plurality of moving images collected as learning data.

For example, the image obtaining unit 101 samples a single moving image at random without replacement from among a plurality of moving images collected as learning data. In other words, when the image obtaining unit 101 randomly selects one moving image from among a plurality of moving images, a method is used to ensure that once-selected moving images are not to be selected again. Further, the image obtaining unit 101 repeats the moving image selection in step S201 a predetermined number of times. If the number of moving images prepared as learning data is smaller than the predetermined number of times, it is not possible to select moving images before the predetermined number of times is reached. For this reason, when the number of moving images is smaller than the predetermined number of times, the image obtaining unit 101 sets all the moving images prepared as learning data, as selection targets again, and then performs sampling without replacement until the predetermined number of times is reached. In other words, when the number of moving images prepared as learning data is smaller than the predetermined number of times, the image obtaining unit 101 allows the once-selected moving images to be selected again in sampling without replacement. The image obtaining unit 101 selects one moving image at one time from among a plurality of moving images collected as learning data, but the image obtaining unit 101 may select a plurality of moving images at one time. When a plurality of moving images is selected at one time in this manner, in step S208 described below, the update unit 105 updates parameters in consideration of the plurality of selected moving images. Such parameter updates are generally referred to as batch learning.

### <Selection Processing of Reference Image and Search Image>

The selection processing of a reference image and a search image performed by the reference image feature obtaining unit 102 and the search image feature obtaining unit 103 in step S202 of FIG. 2 will now be described. As described above, in step S202, the reference image feature obtaining unit 102 and the search image feature obtaining unit 103 select a pair of a reference image and a search image based on preset time intervals from among images of frames included in the moving image selected by the image obtaining unit 101.

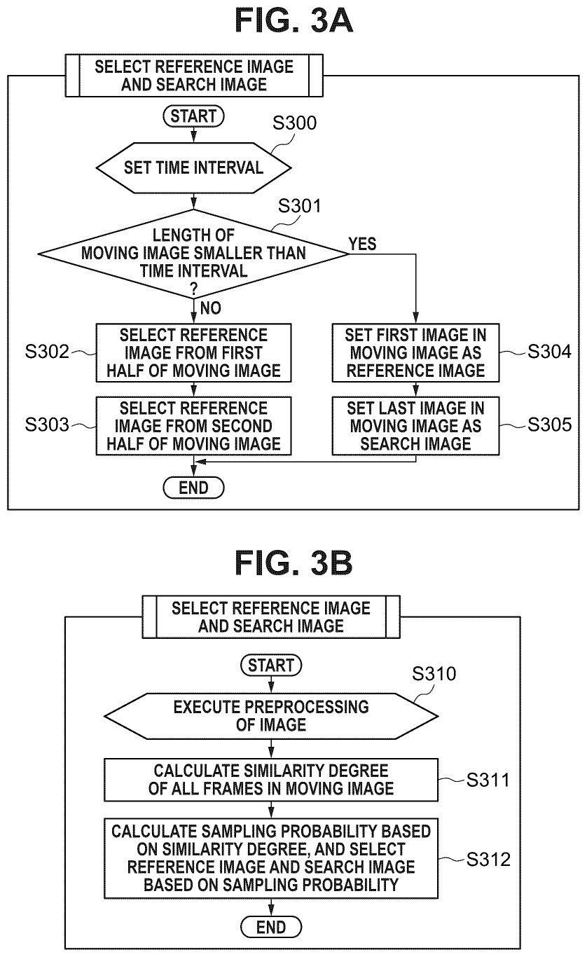

FIG. 3A is a flowchart illustrating details of the selection processing of a reference image and a search image in step S202 of FIG. 2.

In step S300 as preparatory processing before the processing from step S301 onwards, the information processing apparatus 100 sets predetermined time intervals. Hereinafter, the time intervals set in step S300 are referred to as set time intervals. In the present exemplary embodiment, an example is described where time intervals of one second are set as the set time intervals in step S300. If a frame rate of a moving image is 30 frames per second (fps), set time intervals of one second correspond to time intervals of 30 frames. In this case, a pair of a reference image and a search image selected in the flowchart in FIG. 3A is equivalent to a pair of images of frames with an interval equal to or larger than 30 frames corresponding to one set time interval.

In step S301, the information processing apparatus 100 performs conditional branching processing based on the time length of the moving image selected by the image obtaining unit 101 in step S201. For example, if the time length of the moving image is smaller than one set time interval (YES in step S301), the processing of the information processing apparatus 100 proceeds to step S304. On the other hand, if the time length of the moving image is equal to or larger than one set time interval (NO in step S301), the processing proceeds to step S302 and subsequent steps.

If the processing proceeds to step S304 due to the smaller time length of the moving image than one set time interval, the reference image feature obtaining unit 102 selects an image of the first frame of the moving image as a reference image.

In step S305, the search image feature obtaining unit 103 selects an image of the last frame of the moving image as a search image.

For example, if the processing proceeds to step S302 due to the time length of the moving image equal to or larger than one set time interval, the reference image feature obtaining unit 102 selects an image of one frame from the first half frames of the moving image as a reference image. Furthermore, in step S303, the search image feature obtaining unit 103 selects an image of one frame from the second half frames of the moving image as a search image. For example, if the moving image selected in step S201 consists of 50 frames, in step S302, the reference image feature obtaining unit 102 selects one image as a reference image from among images, for example, of the 1st frame to the 20th frame of the moving image. In step S303, the search image feature obtaining unit 103 selects one image as a search image from among images, for example, of the 31st frame to the 50th frame of the moving image.

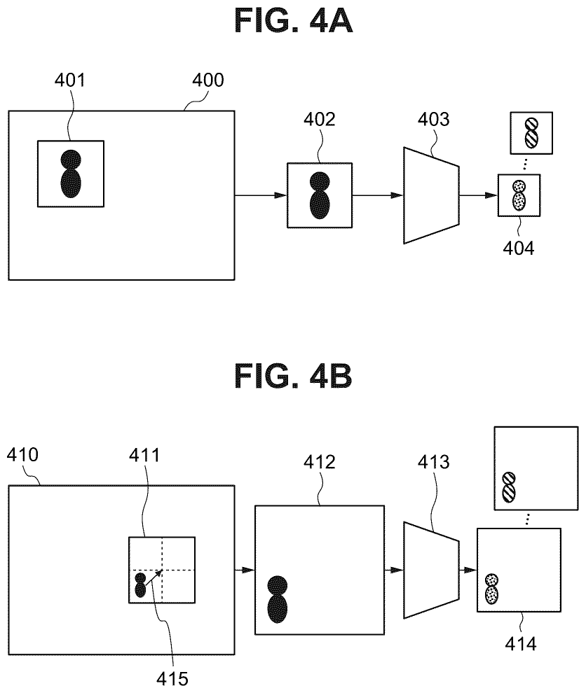

The details of the reference image feature obtaining processing performed by the reference image feature obtaining unit 102 in step S203 of FIG. 2, and the search image feature obtaining processing performed by the search image feature obtaining unit 103 in step S204 of FIG. 2 will now be described with reference to FIGS. 4A and 4B. FIG. 4A is a conceptual diagram of the reference image feature obtaining processing performed by the reference image feature obtaining unit 102, and FIG. 4B is a conceptual diagram of the search image feature obtaining processing performed by the search image feature obtaining unit 103.

### <Reference Image Feature Obtaining Processing>

The reference image feature obtaining processing performed by the reference image feature obtaining unit 102 will be described with reference to FIG. 4A.

It is on the assumption that a reference image 400 as illustrated in FIG. 4A is an RGB image with a width of 4000 pixels and a height of 3000 pixels as described above. The reference image feature obtaining unit 102 initially cuts out a square region encompassing a tracking target as a crop rectangle 401. When the width and the height of the ground truth data corresponding to the reference image 400 are defined as gt_{w} and gtₕ, respectively, the reference image feature obtaining unit 102 calculates a length E (the number of pixels) of one side of the square crop rectangle 401 using formula (1).

$$E = \sqrt{{gt}_{w} \times {gt}_{k} \times A} \qquad ( 1 )$$

In formula (1), A is a parameter representing an area ratio. According to formula (1), an area E² of the square crop rectangle 401 is A times of an area gt_{w}×gtₕ of the region of the tracking target. In the present exemplary embodiment, for example, it is on the assumption that the area ratio A is 5. In addition, the x-coordinate and the y-coordinate of the center of the ground truth data corresponding to the reference image 400 are defined as gtₓ and gt_{y}, respectively. The reference image feature obtaining unit 102 performs crop processing of cutting out the square crop rectangle 401 having a side length of E from the reference image 400 centered at the x and y-coordinates (gtₓ, gt_{y}). In the crop processing, for example, values of black (R, G, B=0, 0, 0) are allocated to pixels of the crop rectangle that extend from the reference image 400.

The reference image feature obtaining unit 102 then performs scaling processing on the image of the crop rectangle 401 to convert the image into an image 402 having a specific resolution. Here, resolution conversion processing performed by the scaling processing is performed to match the input resolution for the subsequent processing. Specifically, the reference image feature obtaining unit 102 includes a reference image feature extractor 403 illustrated in FIG. 4A to perform the resolution conversion processing using the scaling processing to match the input resolution of the reference image feature extractor 403.

For example, if the length of one side of a square image input to the reference image feature extractor 403 is F, the reference image feature obtaining unit 102 needs to scale the image of the crop rectangle 401 by a scaling factor r expressed in formula (2).

$$r = F / E \qquad ( 2 )$$

In the present exemplary embodiment, it is on the assumption that a square image input to the reference image feature extractor 403 has a width of 128 pixels and a height of 128 pixels. The reference image feature extractor 403 outputs a reference image feature 404 extracted from the image 402 subjected to the crop processing and the scaling processing as an intermediate output. For example, the reference image feature extractor 403 uses GoogLeNet, which is a type of convolutional neural network. In the internal processing of the GoogLeNet, the reference image feature extractor 403 obtains an output of an intermediate layer having a resolution that is one-sixteenth of the input resolution as the reference image feature 404. If the length F of one side of the square image input to the reference image feature extractor 403 is 128 pixels, the reference image feature 404 have an output with a width of 8 pixels and a height of 8 pixels, and 832 channels. In the present exemplary embodiment, for example, if 3×3 convolutional layers exist in a convolutional neural network, 3×3 kernel parameters thereof are adjustable parameters in the reference image feature extractor 403.

### <Search Image Feature Obtaining Processing>

The search image feature obtaining processing performed by the search image feature obtaining unit 103 will now be described with reference to FIG. 4B.

The search image feature obtaining unit 103 performs processing of obtaining a search image feature from a search image 410 basically in the same manner as that of the above-described reference image feature obtaining processing. Processing different from the reference image feature obtaining processing alone will be described in the following. While the area ratio A used in the crop processing in the above-described reference image feature obtaining processing is 5, the area ratio A in the search image feature obtaining processing is set to 20. Further, the reference image feature obtaining unit 102 cuts out the square crop rectangle 401 having a side length of E from the reference image 400, centered at the x-coordinate gtₓ and the y-coordinate gt_{y} of the center of the ground truth data with the width gt_{w} and the height gtₕ. In contrast, the search image feature obtaining unit 103 cuts out a square crop rectangle 411 having the side length of E from the search image 410, centered at an x-coordinate dx and a y-coordinate d_{y} expressed in formula (3).

$$( {d}_{x} , {d}_{y} ) = ( {gt}_{x} + {e}_{x} , {gt}_{y} + {e}_{y} ) \qquad ( 3 )$$

In formula (3), eₓ and e_{y} are parameters representing perturbations of the x-coordinate and the y-coordinate of the center. In the example illustrated in FIG. 4B, the arrow in the crop rectangle 411 indicates the perturbation with respect to the x-coordinate and the y-coordinate of the center. The search image feature obtaining unit 103 selects a perturbation magnitude to be applied to the center coordinates from ±E/2 depending on the time interval between the reference image and the search image. While an example of applying perturbation to the search image is described in the present exemplary embodiment, perturbation with a magnitude suitable for the time interval between the reference image and the search image may be applied to the reference image, or perturbation may be applied to both the search image and the reference image.

The search image feature obtaining unit 103 then performs scaling processing on the image of the crop rectangle 411 to convert the image into an image 412 having a specific resolution. In the search image feature obtaining unit 103, resolution conversion processing performed by the scaling processing is performed to match the input resolution for the subsequent processing. Specifically, the search image feature obtaining unit 103 includes a search image feature extractor 413 illustrated in FIG. 4B to perform the resolution conversion processing using the scaling processing to match the input resolution of the search image feature extractor 413.

In the present exemplary embodiment, it is on the assumption that a square image to be input to the search image feature extractor 413 has a width of 256 pixels and a height of 256 pixels. The search image feature extractor 413 outputs a search image feature 414 extracted from the image 412 subjected to the crop processing and the scaling processing as an intermediate output. Similarly to the above-described reference image feature extractor 403, the search image feature extractor 413 uses GoogLeNet, which is a type of convolutional neural network, to obtain an output of an intermediate layer having a resolution that is one-sixteenth of the input resolution as the search image feature 414. In the search image feature extractor 413, If the width and the height of the input square image 412 are each 256 pixels, the search image feature 414 has an output with a width of 16 pixels, a height of 16 pixels, and 832 channels. In the present exemplary embodiment, for example, if 3×3 convolutional layers exist in a convolutional neural network, 3×3 kernel parameters thereof are adjustable parameters in the search image feature extractor 413.

### <Comparison Processing of Reference Image Feature and Search Image Feature>

The comparison processing of a reference image feature and a search image feature performed by the tracking unit 104 in step S205 of FIG. 2 will now be described.

The tracking unit 104 performs a depthwise separable convolution on the reference image feature obtained by the reference image feature obtaining unit 102 and the search image feature obtained by the search image feature obtaining unit 103.

The depthwise separable convolution simplifies calculation by separating the three-dimensional (3D) convolutional processing by kernels in a typical two-dimensional (2D) convolutional layer into two-stage processing including a depthwise convolution (two-dimensional) equivalent to the 3D convolutional processing and a pointwise convolution (one-dimensional). The depthwise separable convolution can be referred to as a channelwise separable convolution. Further, the tracking unit 104 performs zero padding in such a manner that the sizes of a feature to be output and a search image feature are the same as each other. For example, the tracking unit 104 performs a convolution with a kernel size of 3×3 pixel, an input channel number of 832, and an output channel number of 5 on the obtained feature. At this time, similarly to the depthwise separable convolution, the tracking unit 104 performs zero padding in such a manner that the sizes of the feature to be output and the search image feature are the same as each other, resulting in a feature including a width of 16 pixels, a height of 16 pixels, and 5 channels. In the present exemplary embodiment, for example, if 3×3 convolutional layers exist in a convolutional neural network, 3×3 kernel parameters thereof are adjustable parameters in the tracking unit 104.

### <Inference Processing of Position and Size of Tracking Target>

The inference processing of the position and the size of a tracking target performed by the tracking unit 104 in step S206 of FIG. 2 will now be described.

The tracking unit 104 interprets five channels of the feature obtained in the comparison processing in step S205 as a likelihood map M, an x-direction positional shift amount map X, a y-direction positional shift amount map Y, a width map W, and a height map H, and infers the position and the size of a tracking target. Here, the x-coordinate where the value of the likelihood map M is maximum is denoted as pₓ, and the y-coordinate as p_{y}. At this time, if a plurality of pairs of coordinates exists where the value of the likelihood map M is maximum, the tracking unit 104 selects a pair of coordinates closest to the center of the likelihood map. If some distances to the center of the likelihood map are equal, the tracking unit 104 prioritizes a pair of coordinates that are first reached in raster scanning of the likelihood map in a horizontal direction. Then, the tracking unit 104 calculates an inferred value tₓ of the x-coordinate and an inferred value t_{y} of the y-coordinate of the position of the tracking target using formula (4).

$$( {t}_{x} , {t}_{y} ) = ( {p}_{x} \times 16 + X ( {p}_{x} , {p}_{y} ) , {p}_{y} \times 16 + Y ( {p}_{x} , {p}_{y} ) ) \qquad ( 4 )$$

In formula (4), X(pₓ, p_{y}) represents a value at the x-coordinate pₓ and the y-coordinate p_{y} in the x-direction positional shift amount map X, and Y(pₓ, p_{y}) represents a value at the x-coordinate pₓ and the y-coordinate p_{y} in the y-direction positional shift amount map Y. In addition, an inferred value of the width of the tracking target is t_{w}=W(pₓ, p_{y}), and an inferred value of the height of the tracking target is tₕ=H (pₓ, p_{y}).

### <Difference Calculation Processing Between Inference Result and Ground Truth Data>

The difference calculation processing between an inference result and ground truth data performed by the update unit 105 in step S207 of FIG. 2 will now be described.

In step S207 of FIG. 2, the update unit 105 calculates a difference between the inference result and the ground truth data. In the present exemplary embodiment, the update unit 105 calculates a difference L between the inference result and ground truth data using formula (5).

$$L = {I}_{1} {L}_{M} + {I}_{2} {L}_{d} + {I}_{3} {L}_{s} \qquad ( 5 )$$

In formula (5), L_{M} represents a difference with respect to a likelihood map, L_{d} represents a difference with respect to a positional shift amount, and Lₛ represents a difference with respect to a size. The details of these will be described below. In addition, I₁, I₂, and I₃ are hyperparameters, where I₁ is an actual number of 0 or more representing an importance degree of the difference L_{M}, similarly, I₂ is an actual number of 0 or more representing an importance degree of the difference L_{d}, and I₃ is an actual number of 0 or more representing an importance degree of the difference Lₛ. In the present exemplary embodiment, the update unit 105 changes the values of the hyperparameters I₁, I₂, and I₃ according to the time interval between a reference image and a search image, changing an importance degree to be applied to the optimization of parameters of a multilayered neural network.

The difference L_{M} with respect to the likelihood map will now be described.

An example of the image cropped with an area ratio A of 20 using the search image feature obtaining processing in step S204. According to the above-described formula (3), the center coordinates of the tracking target are shifted by the perturbations eₓ and e_{y}. The update unit 105 generates a map of the same size as the search image cropped in step S204, and initializes all elements to zero. Furthermore, the update unit 105 draws a two-dimensional normal distribution centered at coordinates offset by an x-coordinate eₓ and a y-coordinate e_{y} from the center of the map. In addition, the update unit 105 adjust diagonal components of a covariance matrix Σ of the normal distribution according to the width gt_{w} and the height gtₕ of the ground truth data corresponding to the search image. In the present exemplary embodiment, the update unit 105 adjusts the width and the height as expressed in formula (6).

$$\sum = ( \begin{matrix}\frac{{gt}_{w}}{2} & 0 \\ 0 & \frac{{gt}_{h}}{2}\end{matrix} ) \qquad ( 6 )$$

Furthermore, the update unit 105 normalizes all elements of the map where the normal distribution is drawn, to a minimum value of 0 and a maximum value of 1 by dividing the elements by the maximum value of the map. The update unit 105 reduces this to the same size as the search feature (16×16 pixels) as a ground truth likelihood map GT_{M}. Here, the difference L_{M} with respect to the likelihood map can be calculated using the likelihood map M and the ground truth likelihood map GT_{M} as expressed in formula (7).

$${L}_{M} = {\sum }_{i , j} {( M ( i , j ) - {GT}_{M} ( i , j ) )}^{2} \qquad ( 7 )$$

In formula (7), i represents an index in the x-direction of the likelihood map, and j represents an index in the y-direction of the likelihood map.

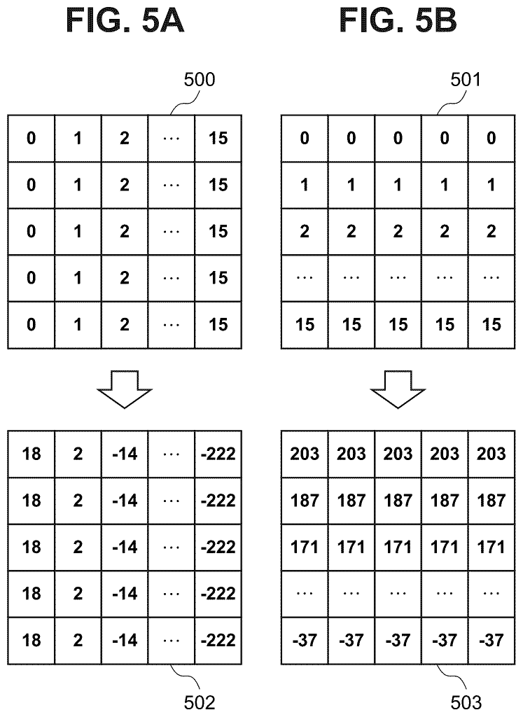

The difference L_{d} with respect to the positional shift amount will now be described with reference to FIGS. 5A and 5B.

First, the update unit 105 generates a two-dimensional mesh grid of the same size as the x-direction positional shift amount map X or the y-direction positional shift amount map Y. A mesh grid 500 in FIG. 5A indicates an example of an x-direction mesh grid Gₓ, and a mesh grid 501 in FIG. 5B indicates an example of a y-direction mesh grid G_{y}. In the present exemplary embodiment, the size of each mesh grid is 16×16 pixels, and each element takes a numerical value ranging from 0 to 15. The ratio of an input resolution to an output resolution of the search image feature extractor 413 is defined as z. In the present exemplary embodiment, the ratio z of the input resolution to the output resolution is 16 (i.e., 256/16).

Furthermore, the update unit 105 performs calculation of formula (8) on each element of the mesh grids to calculate a ground truth x-direction positional shift amount map GT_{X} and a ground truth y-direction positional shift amount map GT_{Y}.

$$\{ \begin{matrix}{GT}_{X} ( i , j ) = \{ \frac{max ( {G}_{x} )}{2} - {G}_{x} ( i , j ) \} \times z + r \times {e}_{x} \\ {GT}_{Y} ( i , j ) = \{ \frac{max ( {G}_{y} )}{2} - {G}_{y} ( i , j ) \} \times z + r \times {e}_{y}\end{matrix} \qquad ( 8 )$$

In formula (8), i represents an x-direction index of the mesh grid, and j represents a y-direction index of the mesh grid. In addition, max (Gₓ) is a maximum element of the x-direction mesh grid Gₓ, which is equal to a maximum element max (G_{y}) of the y-direction mesh grid G_{y}, and is 15. As expressed in the formula (2), r represents the scaling factor of the cropped image. A mesh grid 502 illustrated in FIG. 5A is an example of the ground truth x-direction positional shift amount map GT_{X} at the time of r=1, and eₓ=−102 and e_{y}=83. A mesh grid 503 illustrated in FIG. 5B is an example of the ground truth y-direction positional shift amount map GT_{Y} at the time of r=1, and eₓ=−102 and e_{y}=83.

The update unit 105 calculates the difference L_{d} with respect to the positional shift amount using the ground truth x-direction positional shift amount map GT_{X} and the inference map X, as well as the ground truth y-direction positional shift amount map GT_{Y} and the inference map Y, as expressed in formula (9).

$${L}_{d} = \frac{{\sum }_{i , j} \{ {( X ( i , j ) - {GT}_{X} ( i , j ) )}^{2} + {( Y ( i , j ) - {GT}_{Y} ( i , j ) )}^{2} \}}{2} \qquad ( 9 )$$

In formula (9), i represents an index in the x-direction of the likelihood map, and j represents an index in the y-direction of the likelihood map.

The difference Lₛ with respect to the size will now be described.

First, a map of the same size as a ground truth width map GT_{w} or a ground truth height map GTₕ with uniform elements is considered. The update unit 105 calculates the elements as expressed in formula (10) to obtain the ground truth width map GT_{w} and the ground truth height map GTₕ.

$$\{ \begin{matrix}{GT}_{w} ( i , j ) = {gt}_{w} \times r \\ {GT}_{h} ( i , j ) = {gt}_{h} \times r\end{matrix} \qquad ( 10 )$$

In formula (10), i represents an index in the x-direction of the ground truth width map GT_{w} or the ground truth height map GTₕ, and j represents an index in the y-direction of the ground truth width map GT_{w} or the ground truth height map GTₕ. As expressed in the formula (2), r is the scaling factor of the cropped image.

The update unit 105 calculates the difference Lₛ with respect to the size using the ground truth width map GT_{w} and an inference map W, as well as the ground truth height map GTₕ and an inference map H, as expressed in formula (11).

$${L}_{s} = \frac{{\sum }_{i , j} {( W ( i , j ) - {GT}_{W} ( i , j ) )}^{2} + {( H ( i , j ) - {GT}_{H} ( i , j ) )}^{2} \}}{2} \qquad ( 11 )$$

### <Parameter Update Processing Based on Difference>

The parameter update processing performed by the update unit 105 in step S208 of FIG. 2 will now be described.

In step S208 of FIG. 2, the update unit 105 updates parameters of the reference image feature obtaining unit 102, the search image feature obtaining unit 103, and the tracking unit 104 in FIG. 1 based on the difference L calculated by formula (5). The update unit 105 updates the parameters to minimize the difference using the stochastic gradient descent method, for example. In step S209, the information processing apparatus 100 ends the processing once the updates have been performed a predetermined number of times, for example.

### Effect of First Exemplary Embodiment

The effect of the information processing apparatus according to the present exemplary embodiment will now be described using an example where a gymnast performing a floor exercise is captured and tracked with a digital camera, and the focus is continuously adjusted using the autofocus function. To carry out a tracking function that continuously follows the gymnast during the floor exercise, it is necessary to collect large amounts of moving images of gymnasts performing floor exercises, and prepare learning data with ground truth data. Conventional training techniques involve selecting pairs of images from a certain moving image, randomly from adjacent frames or within a predetermined frame interval, and using those as a reference image and a search image for training. However, in the conventional learning techniques, images of frames showing a gymnast running during a floor exercise are often selected as a reference image and a search image. On the other hand, as the tracking function for a gymnast during a floor exercise, it is desirable to be able to track a gymnast running, as well as the gymnast in states with posture variations due to jumps or twists. However, if images of frames showing the gymnast running are selected as a reference image and a search image, training to handle posture variations, such as jumps and twists, is not efficiently conducted, making it difficult to ensure tracking accuracy for the gymnast during posture change.

In contrast, the information processing apparatus according to the present exemplary embodiment performs learning using a reference image and a search image from a moving image that are highly likely to have a time interval of at least the set time interval or more. Such a pair of images makes it easier to select a reference image and a search image with a posture variation between the images compared with the above-described conventional training techniques. In other words, according to the information processing apparatus of the present exemplary embodiment, learning subjects with posture variations can be performed efficiently, which results in training so as to perform robust object tracking even from moving image data with varying lengths. Thus, the information processing apparatus according to the present exemplary embodiment makes it possible to track subjects with changing postures, such as athletes, with higher accuracy.

A second exemplary embodiment will now be described. As the second exemplary embodiment, an example will be described where a reference image and a search image are selected for training based on a similarity degree between the reference image and the search image. The configuration of the information processing apparatus 100 according to the present exemplary embodiment is similar to that illustrated in FIG. 1, and the procedure of the information processing is generally the same as that of the flowchart in FIG. 2. Thus, the illustration and the description thereof will be omitted.

In the present exemplary embodiment, the selection processing of a reference image and a search image in step S202 of FIG. 2 differs from that in the first exemplary embodiment.

FIG. 3B is a flowchart illustrating details of the selection processing of a reference image and a search image performed in step S202 in the present exemplary embodiment.

In step S310, as preprocessing on images, the reference image feature obtaining unit 102 or the search image feature obtaining unit 103 performs similar crop processing and scaling processing to those described in the first exemplary embodiment on the image of each frame of the moving image selected by the image obtaining unit 101. Preprocessing in step S310 can be performed by either the reference image feature obtaining unit 102 or the search image feature obtaining unit 103, but may be performed by both the reference image feature obtaining unit 102 and the search image feature obtaining unit 103.

In step S311, the reference image feature obtaining unit 102 or the search image feature obtaining unit 103 calculates a similarity degree between the preprocessed images of all frames in the moving image from step S310. The similarity degree calculation processing in step S311 can be performed by either the reference image feature obtaining unit 102 or the search image feature obtaining unit 103, but may be performed by both the reference image feature obtaining unit 102 and the search image feature obtaining unit 103.

In step S312, the reference image feature obtaining unit 102 or the search image feature obtaining unit 103 calculates a sampling probability based on the similarity degree calculated in step S311. The sampling probability calculation processing in step S312 can be performed either the reference image feature obtaining unit 102 or the search image feature obtaining unit 103, but may be performed by both the reference image feature obtaining unit 102 and the search image feature obtaining unit 103. In the present exemplary embodiment, the example is described of calculating a sampling probability based on the similarity degree. However, a sampling probability may be determined based on the time interval described in the first exemplary embodiment.

The reference image feature obtaining unit 102 selects a reference image from the moving image selected by the image obtaining unit 101 based on the sampling probability. The search image feature obtaining unit 103 selects a search image from the moving image selected in step S201 based on the sampling probability.

Image preprocessing, similarity degree calculation processing, and sampling probability calculation processing according to the present exemplary embodiment will now be described in detail. In the present exemplary embodiment, the image preprocessing, the similarity degree calculation processing, and the sampling probability calculation processing are performed by either or both the reference image feature obtaining unit 102 or/and the search image feature obtaining unit 103. However, here, these processes are described as being performed by a feature obtaining unit without distinguishing between the two.

### <Image Preprocessing>

The image preprocessing in step S310 of FIG. 3B will be described.

As a preprocessing for step S310, the feature obtaining unit performs crop processing and scaling processing on all images converted into an image sequence in step S200 of FIG. 2, i.e., RGB images with a width of 4000 pixels and a height of 3000 pixels as described above.

Here, with focus on one image in the image sequence, the width and the height of ground truth data corresponding to the focused image are denoted as gt_{w} and gtₕ, respectively. In the present exemplary embodiment, the feature obtaining unit calculates a length E of one side of a square crop rectangle using formula (1) as described in the first exemplary embodiment. In the image preprocessing in the present exemplary embodiment, the above-described area ratio A is set to 3. In addition, an x-coordinate and a y-coordinate of the center of the ground truth data corresponding to the focused image are denoted as gtₓ and gt_{y}, respectively. As the crop processing in preprocessing on an image, the feature obtaining unit cuts out a rectangle with the length E of one side centered at the x-coordinate gtₓ and the y-coordinate gt_{y} of the center of the ground truth data from the image. In the preprocessing according to the present exemplary embodiment, for example, values of black (R, G, B=0, 0, 0) are allocated to pixels of the crop rectangle that extend beyond the image. The feature obtaining unit performs scaling processing on the image of the crop rectangle cut out in the crop processing at the scaling factor r expressed in the formula (2). One side length F of the image subjected to the scaling processing is set to 32 pixels. In the present exemplary embodiment, the feature obtaining unit applies the above-described preprocessing to all images included in the image sequence.

### <Similarity Degree Calculation Processing>

In step S311, the feature obtaining unit calculates a similarity degree between the preprocessed images corresponding to all frames in the moving image.

The feature obtaining unit inputs all the preprocessed images into the image feature extractor to obtain feature vectors. In the present exemplary embodiment, a 1024-dimensional vector obtained by converting the preprocessed image to a greyscale and performing a horizonal raster scanning is used as feature vectors. Here, if two feature vectors are denoted as u and v, respectively, the similarity degree sim can be calculated using the absolute value of a cosine similarity degree as expressed in formula (12).

$$sim = \frac{\vert uv \vert}{‖ u ‖ ‖ v ‖} \qquad ( 12 )$$

In formula (12), the numerator represents the absolute value of an inner product of the feature vectors, and the denominator represents a product of norms of the respective feature vectors. The value range of the similarity degree sim is 0≤sim≤1. The similarity degree sim is zero when the two features are orthogonal and one when the two features match without considering the signs. The feature obtaining unit calculates the similarity degree sim for all pairs of feature vectors.

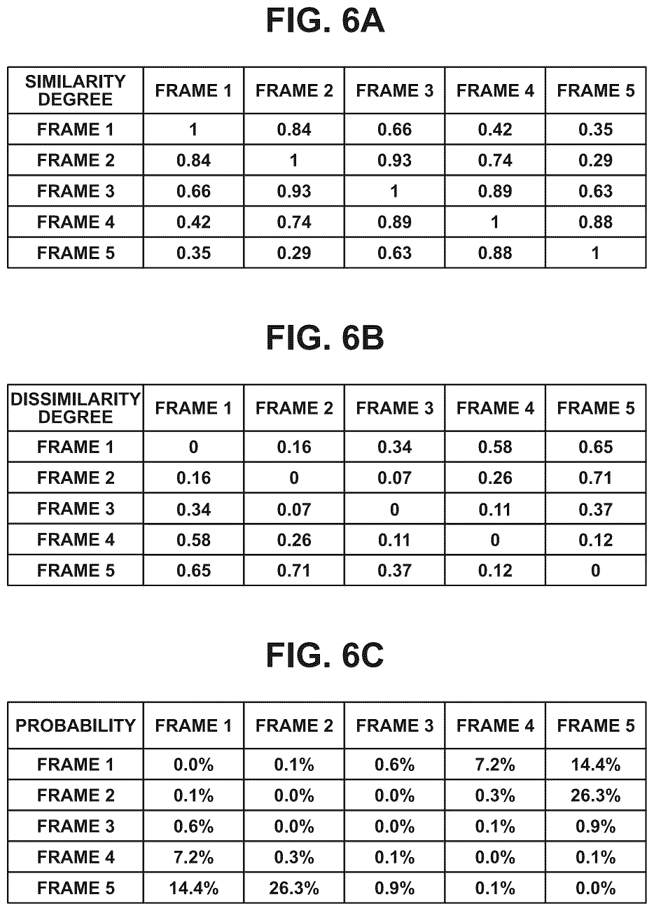

FIG. 6A is a table showing an example of the similarity degree sim when the image sequence consists of five frames, for example, from frame 1 to frame 5. The feature vectors corresponding to the same image are identical, and thus the diagonal elements in FIG. 6A that indicate the similarity degree between the same images are one. Further, a result of formula (12) remains unchanged when the feature vector u and the feature vector v are interchanged, and thus FIG. 6A shows a symmetric matrix. The methods of extracting a feature vector and of calculating a similarity degree described in the present exemplary embodiment are examples, methods such as a color histogram, a histogram of oriented gradients (HOG) feature amount, or a scale-invariant feature transform (SIFT) feature amount, or meta-information such as image capturing time intervals of images or position data on an image capturing location can be used. For calculating a similarity degree, methods such as Mahalanobis distance or Bhattacharyya distance can be used, or a similarity degree can be obtained using a multilayered neural network that has learned feature vector extraction and similarity degree calculation.

### <Sampling Probability Calculation Processing>

In step S312, the feature obtaining unit calculates a sampling probability based on the similarity degree sim calculated in step S311. In the present exemplary embodiment, the feature obtaining unit initially calculates a dissimilarity degree nsim from the similarity degree sim using formula (13).

$$nsim = 1 - sim \qquad ( 13 )$$

FIG. 6B is a table showing the dissimilarity degree corresponding to FIG. 6A.

Then, when a sampling probability with the i-th frame as the reference feature and the j-th frame as the search feature is denoted as p(i, j), the feature obtaining unit calculates the sampling probability p(i, j) using formula (14) with a temperature-scaled softmax function.

$$p ( i , j ) = \frac{{e}^{\frac{{nsim}_{i , j}}{T}}}{{\sum }_{k , m} {e}^{\frac{{nsim}_{k , m}}{T}}} \qquad ( 14 )$$

In formula (14), nsim_{i,j} represents the dissimilarity degree between the i-th frame and the j-th frame. k and m represent all pairs of frames, and nsim_{k,m} represents the dissimilarity degree between the k-th frame and the m-th frame. T is a hyperparameter with 0≤T, and for example, at the time of T=0, the sampling probability for pairs of images other than the pair of images having the maximum dissimilarity degree is zero. As the value of T increases, the probability of selecting pairs of images of frames having low dissimilarity degrees increases, and at the time of T=∞, the sampling probability is uniform.

FIG. 6C is a table showing the sampling probability corresponding to FIG. 6B. FIG. 6C is an example of a case of T=0.1.

In the present exemplary embodiment, the reference image feature obtaining unit 102 selects the i-th frame sampled based on the above-described sampling probability as a reference image, and the search image feature obtaining unit 103 selects the j-th frame as a search image. At this time, the selected reference image and the search image are RGB images each with a width of 4000 pixels and a height of 3000 pixels before the image preprocessing in step S301 of FIG. 3.

### Effect of Second Exemplary Embodiment

The effect of the information processing apparatus according to the present exemplary embodiment will be described using an example where a flapping bird is captured and tracked with a digital camera, and the autofocus function continuously adjusts the focus.

To carry out a tracking function that continuously follows a flapping bird, it is necessary to collect large amounts of moving images of flapping birds, and prepare learning data to which ground truth data is provided. In conventional training technique, for example, a pair of images are selected from a moving image of birds flying in a straight line, and those are used as a reference image and a search image. However, posture variations of birds frying in a straight line are periodic. If a reference image and a search image with the same posture are selected, efficient training that corresponds to the posture variations caused by the bird's flapping is not performed. Consequently, this makes it difficult to ensure tracking accuracy.

In contrast, in the information processing apparatus according to the present exemplary embodiment, a reference image and a search image are selected based on a dissimilarity degree. Thus, even if posture variations are periodic, a reference image and a search image with different postures from each other are selected, making it possible to perform efficient training that handles the posture variations. In other words, the information processing apparatus of the present exemplary embodiment allows learning subjects with posture variations efficiently, i.e., training that enables robust object tracking against posture variations of a tracking target. This configuration according to the information processing apparatus of the present exemplary embodiment makes it possible to accurately track a bird whose posture varies due to its flapping, for example.

A third exemplary embodiment will now be described. As the present exemplary embodiment, an example of obtaining a search image to which a perturbation with a magnitude based on a similarity degree is applied, i.e., an example of obtaining a search image with a greater magnitude of the perturbation as a similarity degree increases (or, as a dissimilarity degree decreases). A perturbation with a magnitude based on a similarity degree can be applied to a search image, as well as to a reference image, or to both a reference image and a search image. The configuration and processing of the information processing apparatus 100 according to the present exemplary embodiment are the same as those described in FIGS. 1 and 2, the illustration and description thereof will be omitted.

In the first exemplary embodiment, in step S204 of FIG. 2, the search image feature obtaining unit 103 applies the perturbations eₓ and e_{y} to the x-coordinate and the y-coordinate of the center, respectively, according to the time interval between a reference image and a search image. In contrast, in the present exemplary embodiment, the corrected perturbations ceₓ and ce_{y}, are applied after making corrections based on a similarity degree on the perturbations eₓ and e_{y} according to the time interval between the reference image and the search image. formula (15) shows the corrected perturbations ceₓ and ce_{y} based on a similarity degree.

$$( {ce}_{x} , {se}_{y} ) = ( sim \times {e}_{x} , sim \times {e}_{y} ) \qquad ( 15 )$$

In formula (15), the greater the magnitudes of the corrected perturbations ceₓ and ce_{y}, the higher the similarity degree, and the smaller the magnitudes, the lower the similarity degree. In the present exemplary embodiment, perturbations to the center coordinates alone are applied, but other perturbations, such as affine transformation and color transformation can be combined and added.

The following is a description of an example of image transformation using composition of affine transformations, which applies perturbation based on a similarity degree. In the first exemplary embodiment, the perturbations eₓ and e_{y} are applied when a search image is cropped. In the present exemplary embodiment, instead of applying perturbations when an image is cropped, image transformation using the composition of affine transformations based on a similarity degree is performed. In the present exemplary embodiment, a length E of one side of a crop rectangle cut out from the search image without perturbation is set to 256 pixels. In the present exemplary embodiment, the search image feature obtaining unit 103 applies processing obtained by the composition of affine transformations expressed in formulae (16) to (20) to the image of the crop rectangle cut out in the crop processing with respect to its center based on a similarity degree.

$$FLX = ( \begin{matrix}- 1 & 0 & 0 \\ 0 & 1 & 0 \\ 0 & 0 & 1\end{matrix} ) \qquad ( 16 )$$

$$SHI = ( \begin{matrix}1 & 0 & {shi}_{x} \\ 0 & 1 & {shi}_{y} \\ 0 & 0 & 1\end{matrix} ) \qquad ( 17 )$$

$$SCA = ( \begin{matrix}{sca}_{x} & 0 & 0 \\ 0 & {sca}_{y} & 0 \\ 0 & 0 & 1\end{matrix} ) \qquad ( 18 )$$

$$SHE = ( \begin{matrix}1 & tan ( {deg}_{x} ) & 0 \\ tan ( {deg}_{y} ) & 1 & 0 \\ 0 & 0 & 1\end{matrix} ) \qquad ( 19 )$$

$$ROT = ( \begin{matrix}cos ( deg ) & - sin ( deg ) & 0 \\ sin ( deg ) & cos ( deg ) & 0 \\ 0 & 0 & 1\end{matrix} ) \qquad ( 20 )$$

In formula (16), FLX represents mirror image transformation with respect to the x-direction. In formula (17), SHI represents parallel translation transformation of an image, shiₓ represents a parallel translation amount in the x-direction, and shi_{y} represents a parallel translation amount in the y-direction. In formula (18), SCA represents scaling processing of an image, scaₓ represents a scaling ratio in the x-direction, and sca_{y} represents a scaling ratio in the y-direction. In formula (19), SHE represents shearing processing of an image, degₓ represents a shear angle in the x-direction, deg_{y} represents a shear angle in the y-direction. In formula (20), ROT represents rotation processing of an image, and deg represents a rotational angle. In the present exemplary embodiment, the values are random numbers determined from the range expressed in formula (21).

$$\begin{matrix}0 \leq {shi}_{x} , {shi}_{y} \leq 128 \\ 0.5 \leq {sca}_{x} , {sca}_{y} \leq 2 \\ 0 \leq {deg}_{x} , {deg}_{y} \leq 45 \\ 0 \leq deg 〈 360\end{matrix} \qquad ( 21 )$$

A compound matrix C of the affine transformation according to the present exemplary embodiment is defined by formula (22).

$$\begin{matrix}C = sel ( sim , ROT ) \cdot sel ( sim , SHE ) \cdot sel ( sim , SCA ) \\ sel ( sim , SHI ) \cdot sel ( sim , FLX )\end{matrix} \qquad ( 22 )$$

In formula (22), a dot operator (⋅) represents a dot product of the matrix. A function sel( ) generates a uniform random number rand satisfying 0≤rand≤1. If the condition rand≤sim is satisfied, a value (ROT, etc.) of the given conversion matrix is taken, and if the condition is unsatisfied, a 3×3 identity matrix is taken. The corrected perturbations ceₓ and ce_{y} according to the present exemplary embodiment can be calculated using elements c₁₁ to c₂₃ of the compound matrix C of the affine transformation as expressed in formula (23).

$$\begin{matrix}C = ( \begin{matrix}{c}_{11} & {c}_{12} & {c}_{13} \\ {c}_{21} & {c}_{22} & {c}_{23} \\ 0 & 0 & 1\end{matrix} ) \\ ( {ce}_{x} , {ce}_{y} , 1 ) = ( \begin{matrix}{c}_{11} & {c}_{12} & {c}_{13} \\ {c}_{21} & {c}_{22} & {c}_{23} \\ 0 & 0 & 1\end{matrix} ) ( \begin{matrix}127.5 \\ 127.5 \\ 1\end{matrix} ) = ( \begin{matrix}127.5 {c}_{11} + 127.5 {c}_{12} + {c}_{13} \\ 127.5 {c}_{21} + 127.5 {c}_{22} + {c}_{23} \\ 1\end{matrix} )\end{matrix} \qquad ( 23 )$$

A fourth exemplary embodiment will now be described. As the fourth exemplary embodiment, an example will be described where the update unit 105 calculates a difference between the inference result and the ground truth data in step S207 of FIG. 2, considering a dissimilarity degree. The configuration and the processing of an information processing apparatus 100 according to the present exemplary embodiment are similar to those in FIGS. 1 and 2 described above, the illustration and the description thereof will be omitted. In the first exemplary embodiment, the difference L is calculated using formula (5). In the present exemplary embodiment, the update unit 105 calculates a corrected difference cL based on a dissimilarity degree nsim as expressed in formula (24).

$$cL = nsim \times L \qquad ( 24 )$$

As understood from formula (24), the corrected difference cL increases as the dissimilarity degree nsim increases. Thus, when the parameters is updated using the corrected difference cL as in step S208 of FIG. 2, the larger the difference is, the more significantly parameters are updated to reduce the difference. In other words, according to formula (24), the importance of optimizing the parameters for images with high dissimilarity degrees is increased, and it is more likely that the parameters will be updated more intensively compared with images with low dissimilarity degrees.

Furthermore, in the present exemplary embodiment, the number of times the parameters have been updated can be added as an importance degree for parameter optimization. In the present exemplary embodiment, the predetermined number of times determined in step S209 of FIG. 2 is set to, for example, 10000 times. When the current number of parameter updates is denoted as iter, the update unit 105 calculates the corrected difference cL as expressed in formula (25).

$$cL = \{ \begin{matrix}L & ( iter 〈 5000 ) \\ nsim \times L & ( otherwise )\end{matrix} \qquad ( 25 )$$

According to formula (25), when the number of parameter updates is small, the updates are performed without considering dissimilarity degrees. After updating the parameters half of the predetermined times (i.e., 500 times), the update unit 105 calculates the corrected difference cL based on the dissimilarity degree. While the predetermined number of 1000 times, and the number of 500 times at which the dissimilarity degree starts being considered in the present exemplary embodiment are merely examples, the numbers in the present disclosure are not limited to those.

### <Hardware Configuration of Information Processing Apparatus>

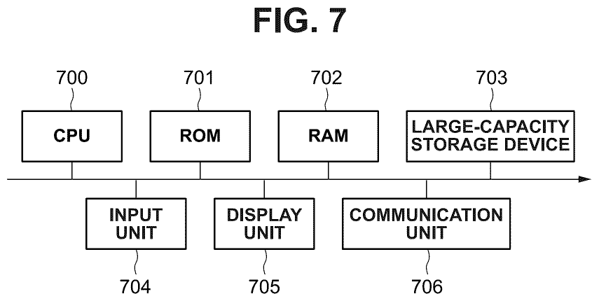

FIG. 7 is a diagram illustrating a hardware configuration example applicable to the above-described information processing apparatus according to each exemplary embodiment.

A central processing unit (CPU) 700 performs calculation and logical determination for various types of processing. A read-only memory (ROM) 701 stores control programs. A random-access memory (RAM) 702 is used as a main memory or as a temporary storage region, such as a working area for the CPU 700.

A large-capacity storage device 703 stores various types of data, such as an information processing program according to the present exemplary embodiment, image data, and ground truth data. The CPU 700 executes the information processing program according to the present exemplary embodiment, which is read from the large-capacity storage device 703 and loaded into the RAM 702, to perform the information processing as described in the above-described exemplary embodiments.

An external storage device can be used to have the same role as the large-capacity storage device 703. The external storage device can be implemented by, for example, a medium (a storage medium) and an external storage drive for accessing to the medium. Examples of such media include a flexible disc (FD), a compact disc read-only memory (CD-ROM), a digital versatile disc (DVD), a universal serial bus (USB) memory, a magneto-optical disc (MO), and a flash memory. In addition, the external storage device can be a server device connected via a network.

An input unit 704 includes a keyboard, a touch panel, and various buttons, and receives instructions from the user. A display unit 705 includes a liquid crystal display, and is capable of displaying various types of data and information processing results to the user. This apparatus can communicate with another apparatus, such as the imaging apparatus 110, via a communication unit 706. This apparatus may receive user instructions from another apparatus via the communication unit 706, and may output processing results to that apparatus. The information processing apparatus of the present exemplary embodiment can be implemented by a general-purpose personal computer, a tablet terminal, or a smartphone, all of which have the above-described configuration.

In the first exemplary embodiment described above, a pair of a reference image and a search image is selected based on a set time interval, and in the second exemplary embodiment, a pair of a reference image and a search image is selected based on a dissimilarity degree. However, a pair of a reference image and a search image can be selected using both the set time interval and the dissimilarity degree. For example, even if an interval between two images is equal to or larger than the set time interval, the posture of a tracked subject is hardly changed in some cases. In such cases, two images with a high dissimilarity degree can be selected.

### Other Exemplary Embodiments

The present disclosure can be implemented by processing of supplying programs that carry out one or more functions of the above-described exemplary embodiments to a system or an apparatus via a network or a storage medium, and one or more processors in a computer of the system or the apparatus reading the programs and executing the programs. The present disclosure can also be implemented by a circuit, such as Application Specific Integrated Circuit (ASIC) that carries out one or more functions.

The above-described exemplary embodiments are merely examples of embodiments for implementing the present disclosure, and the technical scope of the present disclosure is not to be interpreted in a limited manner based on those. In other words, the present disclosure can be implemented in various forms without departing from the technical concept or the main features.

Depending on the movement of a subject, it is often unable to capture a moving image whose subject is being caught in a screen for a sufficiently long time, resulting in variations in the length of moving images. Especially, with short moving image data, the variation in the appearance of the subject tends to be small. With the data on such short moving images, data sets with smaller variations in the appearance of the subject between reference images and search images are generated. Consequently, a multilayered neural network for object tracking trained using data sets with small variations in the appearance of the subject tends to have difficulty handling variations in the appearance of the subject due to changes in posture and other factors.

According to the present disclosure, even when moving image data to be used for training varies in length, a neural network can be trained robustly against variations in target subjects.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-099754, which was filed on Jun. 20, 2024 and which is hereby incorporated by reference herein in its entirety.

What is claimed is:

1. An information processing apparatus comprising:
at least one processor; and
at least one memory that is in communication with the at least one processor, wherein the at least one memory stores instructions for causing the at least one processor and the at least one memory to:
obtain a plurality of time-series images;
select a reference image and a search image from among the plurality of time-series images based on at least any of a time at which the plurality of time-series images is captured, a predetermined time interval, and a dissimilarity degree between the plurality of time-series images; and
infer, based on the reference image and the search image selected from among the plurality of time-series images, a target subject in the search image that corresponds to the target subject in the reference image to update a parameter of a neural network based on an inference result and ground truth data.

2. The information processing apparatus according to claim 1, wherein the at least one memory further stores instructions for causing the at least one processor and the at least one memory to:
obtain an image feature from the reference image using a neural network;
obtain an image feature from the search image using a neural network;
infer the target subject in the search image that corresponds to the target subject in the reference image, using a neural network, based on the image feature of the reference image and the image feature of the search image; and
update, based on the inference result and the ground truth data, a parameter of at least any network of the neural network used to obtain the image feature of the reference image, the neural network used to obtain the image feature of the search image, and the neural network used to perform the inference.

3. The information processing apparatus according to claim 2, wherein the at least one memory further stores instructions for causing the at least one processor and the at least one memory to track the target subject with inference of the target subject in the search image that corresponds to the target subject in the reference image.

4. The information processing apparatus according to claim 1, wherein the at least one memory further stores instructions for causing the at least one processor and the at least one memory to update the parameter in a case where a time interval between the reference image and the search image is equal to or larger than the predetermined time interval.

5. The information processing apparatus according to claim 1, wherein the at least one memory further stores instructions for causing the at least one processor and the at least one memory to select the reference image and the search image according to a sampling probability based on a time interval between the reference image and the search image.

6. The information processing apparatus according to claim 1, wherein the at least one memory further stores instructions for causing the at least one processor and the at least one memory to select the reference image and the search image according to a sampling probability based on a dissimilarity degree between the reference image and the search image.

7. The information processing apparatus according to claim 1, wherein the at least one memory further stores instructions for causing the at least one processor and the at least one memory to apply a perturbation with a magnitude varying according to a time interval between the reference image and the search image, to at least one of the reference image and the search image.

8. The information processing apparatus according to claim 1, wherein the at least one memory further stores instructions for causing the at least one processor and the at least one memory to apply a perturbation with a magnitude varying according to a dissimilarity degree between the reference image and the search image, to at least one of the reference image and the search image.

9. The information processing apparatus according to claim 1, wherein the at least one memory further stores instructions for causing the at least one processor and the at least one memory to change an importance degree for update of the parameter according to a time interval between the reference image and the search image.

10. The information processing apparatus according to claim 1, wherein the at least one memory further stores instructions for causing the at least one processor and the at least one memory to change an importance degree for update of the parameter according to a dissimilarity degree between the reference image and the search image.

11. The information processing apparatus according to claim 10, wherein the at least one memory further stores instructions for causing the at least one processor and the at least one memory to use, as the importance degree, a corrected difference obtained by correcting a difference between the target subject inferred from the search image and the ground truth data based on the dissimilarity degree.

12. The information processing apparatus according to claim 11, wherein the at least one memory further stores instructions for causing the at least one processor and the at least one memory to calculate the corrected difference according to the number of times the parameter is updated.

13. An information processing method comprising:
image obtaining of obtaining a plurality of time-series images; and
training of inferring, based on a reference image and a search image obtained from the plurality of time-series images, a target subject in the search image that corresponds to a target subject in the reference image, and updating a parameter of a neural network based on an inference result and ground truth data,
wherein the training selects the reference image and the search image from among the plurality of images based on at least any of a time at which the plurality of time-series images is captured, a predetermined time interval, and a dissimilarity degree between the plurality of time-series images.

14. A non-transitory computer-readable storage medium storing computer-executable instructions for causing a computer to perform operations that comprise:
obtaining a plurality of time-series images;
selecting a reference image and a search image from among the plurality of time-series images based on at least any of a time at which the plurality of time-series images is captured, a predetermined time interval, and a dissimilarity degree between the plurality of time-series images; and
inferring, based on the reference image and the search image selected from among the plurality of time-series images, a target subject in the search image that corresponds to a target subject in the reference image, and updating a parameter of a neural network based on an inference result and ground truth data.
